(19) United States
(12) Patent Application Publication
(10) Pub. No.: US 2011/0067978 A1
(43) Pub. Date: Mar. 24, 2011

(54) APPARATUS FOR CLEANING CONVEYOR BELT

(76) Inventors: Geneva Carman, Lutz, FL (US); David Winnecour, LandoLakes, FL (US)

(21) Appl. No.: 12/564,787

(22) Filed: Sep. 22, 2009

(51) Int. Cl. B65G 45/22

(52) U.S. Cl. 198/495

(57) ABSTRACT

One embodiment of an apparatus for cleaning a conveyor belt includes a container. The container includes a chamber adapted to store a fluid therein. Further, the chamber terminates in an opening. The apparatus may also include a fluid distributing member that may extend from the chamber and through the opening. Furthermore, the fluid distributing member may be rotatable with respect to the container. Moreover, the fluid distributing member may be capable of receiving the fluid from the chamber and distributing the fluid onto the conveyor belt spaced apart from the container to clean the conveyor belt.

### FIELD OF THE DISCLOSURE

The present disclosure generally relates to cleaning apparatuses, and more particularly, to an apparatus for cleaning a conveyor belt.

### BACKGROUND OF THE DISCLOSURE

Retail stores may have a series of checkout stations including cash registers used to record a transaction for each good that a consumer purchases from the store. Each checkout station may include a conveyor belt that may carry the goods from one end of the station to the other end adjacent to the cash register. Examples of these goods may include packaged raw meat, poultry, fish, fruit, vegetables, toiletries, clothing and children's toys. The goods may carry microorganisms, such as viruses or bacteria, that may contaminate the conveyor belt and then transfer to the goods of other consumers. By way of example, a consumer, who is infected with the H1N1 virus, may transfer the virus to the goods that he places onto the conveyor belt, thereby contaminating the conveyor belt and requiring an employee to spend a significant amount of time repeatedly sanitizing the conveyor belt. This may also lead to somewhat lengthy waiting times for other consumers using the same checkout station.

The goods, such as produce, may be placed in plastic bags before being loaded onto the conveyor belt in order to block the transfer of contaminants between the goods and the conveyor belt. However, contaminants may still transfer between the plastic bags and the conveyor belt thereby still spreading the contaminants between the consumers. In addition, the mass production of plastic bags may lead to significant carbon emissions. Further, the plastic bags may not biodegrade but rather pollute coastal lines and harm marine animal life, which perceive the bags as food and subsequently ingest the same.

### SUMMARY OF THE DISCLOSURE

One embodiment of an apparatus for cleaning a conveyor belt may include a container, which may have a chamber adapted to store a fluid therein. The chamber terminates in an opening. The apparatus may also include a fluid distributing member that may extend from the chamber and through the opening. Moreover, the fluid distributing member may be rotatable with respect to the container. Additionally, the fluid distributing member may be capable of receiving the fluid from the chamber and distributing the fluid onto the conveyor belt to clean the conveyor belt.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a perspective view of an embodiment of an apparatus for cleaning a conveyor belt;

FIG. 2 is an exploded view of the apparatus of FIG. 1; and

FIG. 3 depicts the apparatus of FIG. 1 being utilized for cleaning the conveyor belt.

Like reference numerals refer to like parts throughout the description of several views of the drawings.

### DETAILED DESCRIPTION OF THE DISCLOSURE

The exemplary embodiments described herein provide detail for illustrative purposes only and are subject to many variations in structure and design. It should be emphasized, however, that the present disclosure is not limited to a particular apparatus for cleaning a conveyor belt, as shown and described. It is understood that various omissions and substitutions of equivalents are contemplated as circumstances may suggest or render expedient, but these are intended to cover the application or embodiment without departing from the spirit or scope of the claims of the present invention. Also, it is to be understood that the phraseology and terminology used herein are for the purpose of description and should not be regarded as limiting. The terms “a” and “an” herein do not denote a limitation of quantity, but rather denote the presence of at least one of the referenced item.

Unless limited otherwise, the terms “mounted,” “coupled,” and variations thereof herein are used broadly and encompass direct and indirect attachments and arrangements.

The present disclosure provides an apparatus for cleaning a conveyor belt. The term “cleaning” as used herein relates to a process of sanitizing and/or removing the contaminants, such as microorganisms, and the like from the conveyor belt.

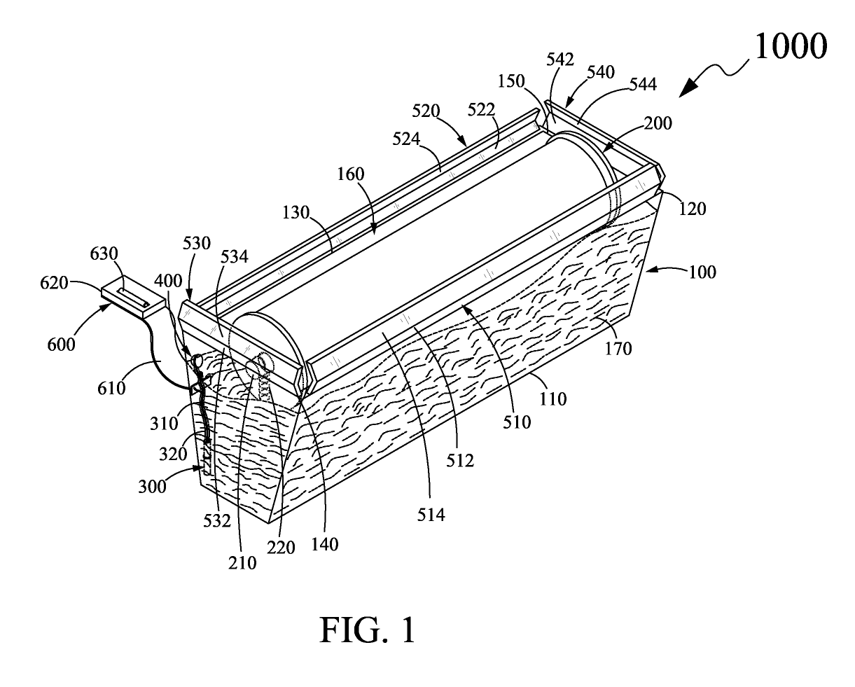

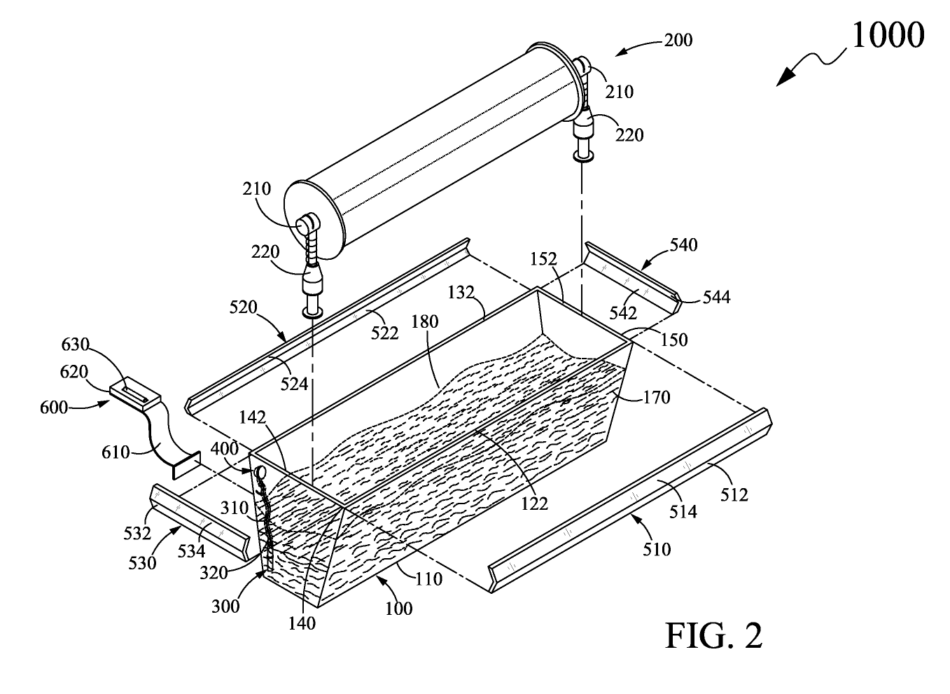

Further, the conveyor belt may be configured to move around a pair of spaced apart rollers so that various items, such as grocery items may be placed on the conveyor belt. The apparatus of the present disclosure is explained in detail in conjunction with FIGS. 1 and 2, wherein FIG. 1 is a perspective view of an apparatus 1000 and FIG. 2 is an exploded view of the apparatus 1000.

Referring to FIGS. 1 and 2, one embodiment of the apparatus 1000 may include a container 100 that may include a base member 110 and a plurality of peripheral walls that may extend upwards from the base member 110. The peripheral walls may include a front wall 120, a rear wall 130, and a pair of sidewalls 140 and 150. The base member 110 and the peripheral walls may collectively configure a chamber 160. The chamber 160 may be adapted to store a fluid 170 therein. The fluid 170 may be a quick drying anti-bacterial fluid or any other suitable disinfectant fluid. Further, the chamber 160 may terminate with an opening 180 (as shown in FIG. 2).

The apparatus 1000 may also have a fluid distributing member 200 that may extend from the chamber 160 and through the opening 180. Further, the fluid distributing member 200 in this form may be a roller, which may be rotatably carried by the container 100 and may have nubs for gripping the conveyor belt. Specifically, the fluid distributing member 200 may be rotatably carried by a spring-loaded spindle 210. The spindle 210 may extend throughout a length of the fluid distributing member 200. Furthermore, opposing end portions of the spindle 210 may be carried by spring-loaded fittings 220 (as shown in FIG. 2). The fittings 220 may be disposed on the base member 110 of the container 100 by means of any suitable mechanical fasteners known in the art. The fittings 220 may move the fluid distributing member 200 upwards against the conveyor belt such that the fluid distributing member 200 is in contact with the conveyor belt. The fluid distributing member 200 may rotate such that the fluid distributing member 200 may receive the fluid 170 from the chamber 160 and distribute the fluid 170 onto the conveyor belt to clean the conveyor belt. Of course, the fluid distributing member 200 may instead be other suitable devices for receiving the fluid 170 from the chamber 160 and distributing the fluid 170 onto the conveyor belt.

The apparatus 1000 may also include a level detector 300 disposed within the container 100. Specifically, the level detector 300 may be carried by the base member 110 of the container 100. The level detector 300 in this form may be a flotation device capable of measuring a level of the fluid 170 in the chamber 160. The level detector 300 may be made of a stainless steel material. Alternatively, the level detector 300 may have a housing that may be made of a suitable non-corrosive material other than the stainless steel material.

Further, the apparatus 1000 may include an indicator 400 operatively coupled to the level detector 300. In an embodiment of the present disclosure, the indicator 400 may be connected to the level detector 300 through electrical wires, such as electrical wires 310. The electrical wires 310 may be enclosed in a waterproof covering, such as a covering 320. The indicator 400 is adapted to provide an indication when the level of the fluid 170 is detected to be less than a predetermined threshold level of the fluid 170. Specifically, the level detector 300 may be preset to activate the indicator 400 when the level of the fluid 170 falls below the predetermined threshold level. In an exemplary embodiment, the predetermined threshold level of the fluid 170 may be related to a minimum fluid level necessary for functioning of the fluid distributing member 200. In the present embodiment, the indicator 400 is an indicator light which may turn red when the level of the fluid 170 falls below the predetermined threshold level. However, the indicator 400 may be any other suitable indicating means known in the art, such as an alarm and the like. In an alternate embodiment, the indicator 400 may be two indicator lights, such as a red light for providing indication when the level of the fluid 170 falls below the predetermined threshold level, and a green light for providing indication when the level of the fluid 170 is at an optimum level.

Referring to FIG. 1, the apparatus 1000 may also include a fastener 510, a fastener 520, a fastener 530 and a fastener 540 (hereinafter collectively referred to as the fasteners 510, 520, 530, and 540) disposed on an outer surface of the container 100. As illustrated in FIG. 1, the fasteners 510, 520, 530, and 540 may be carried by a respective one of top edge portions 122, 132, 142 and 152 of the peripheral walls 120, 130, 140, and 150. Alternatively, the fasteners may be disposed on one of the front wall 120, the rear wall 130, and the sidewalls 140 and 150, or any combination thereof. Further, it will be evident to a person skilled in the art that the fasteners 510, 520, 530, and 540 may be disposed on the outer surface of the container 100 by any suitable means known in the art, such as an adhesive strip, and the like

The fasteners 510, 520, 530 and 540 are configured to removably attach the container 100 with a support member of the conveyor belt. Moreover, the fasteners 510, 520, 530 and 540 in this form may be clip fasteners. Specifically, the fastener 510 may include an elongated vertical member 512 and an elongated horizontal member 514 extending upwardly and inwardly from the elongated vertical member 512. Similarly, the fasteners 520, 530 and 540 may include vertical members 522, 532 and 542, and horizontal members 524, 534 and 544, respectively.

In addition, the apparatus 1000 may include a light source attachment 600 coupled to the container 100 such that the light source may disinfect the conveyer belt. The light source attachment 600 may be carried by the rear wall 130 of the container 100. However, the light source attachment 600 may instead be carried by any other peripheral wall. Further, the light source attachment 600 may be coupled to the container 100 by any suitable fastener. The light source attachment 600 may also include an arm extension 610, and a housing 620 coupled to the arm extension 610. The housing 620 may be coupled to the arm extension 610 by means of welding and/or mechanical fasteners. The arm extension 610 may be carried by the container 100. The housing 620 includes a light source 630 that may be capable of producing UV light for disinfecting the conveyor belt, thereby cleaning the conveyor belt.

In an embodiment of the present disclosure, the light source 630 may be activated when the level of the fluid 170 in the container 100 is less than the predetermined threshold level of the fluid 170. In an alternative embodiment, the light source 630 may be activated whenever the conveyer belt is being cleaned and disinfected by the fluid 170 contained in the container 100. In other words, the disinfecting fluid and the UV light may work in conjunction for disinfecting the conveyer belt. The light source attachment 600 may be made of a water resistant material. Specifically, the housing 620 enclosing the light source 630 may be made of a water resistant material. The water resistant material may guard the light source attachment 600 from getting damaged by the fluid 170. Of course, though FIGS. 1 and 2 depict particular shapes and sizes of the apparatus 1000 and various components thereof; the apparatus 1000 and the various components thereof may be any other suitable shapes and sizes.

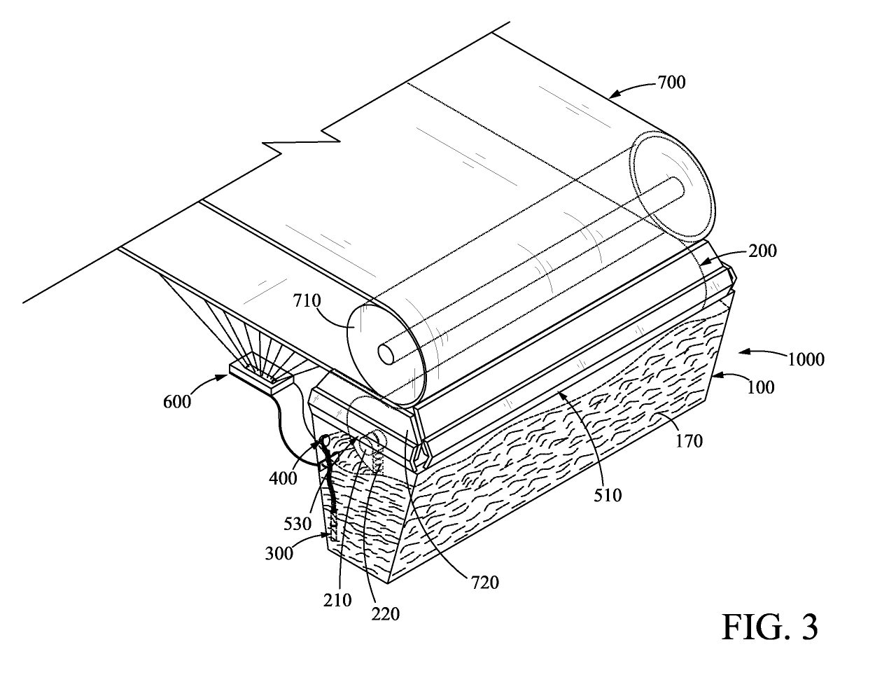

Referring now to FIGS. 1-3, the conveyor belt 700 may be configured to move along a pair of spaced apart rollers, such as a roller 710. Further, the conveyor belt 700 includes a support member 720 that may be carried by an end portion of the conveyor belt 700 such that the conveyor belt 700 remains exposed for cleaning thereof. The fasteners 510, 520, 530 and 540 may removably coupled to the support members, such as the support member 720, such that the container 100 is removably attached to the support members. Specifically, the horizontal members 514, 524, 534, and 544 of a respective one of the fasteners 510, 520, 530 and 540 may engage the support members, such as the support member 720. It will be evident to a person skilled in the art that the support member 720 is designed to completely receive the horizontal members 514, 524, 534, and 544 of the fasteners 510, 520, 530 and 540.

After the container 100 is attached to the support member 720 of the conveyor belt 700, the fluid distributing member 200 may rotate so as to maintain a contact with the conveyor belt 700. The fluid distributing member 200 may receive the fluid 170 from the chamber 160 and distribute the received fluid onto the conveyor belt 700. Accordingly, the contaminants present on the conveyor belt 700 are removed, thereby cleaning the conveyor belt 700. The light source 630 of the light source attachment 600 may scatter UV light onto the conveyor belt to further disinfect the conveyor belt 700.

In another embodiment of the present disclosure, the level detector 300 may continuously measure the level of the fluid 170 in the chamber 160. When the level of the fluid 170 is detected to be below the predetermined threshold level of the fluid 170, the level detector 300 may activate the indicator 400. The indicator 400 may then provide an indication for refilling of the chamber 160 with the fluid 170. Moreover, when the level of the fluid 170 in the container 100 is less than the predetermined threshold level, the light source attachment 600 may get activated. Once the light source attachment 600 is activated, the light source 630 may produce UV light for disinfecting the conveyor belt 700, thereby cleaning the conveyor belt 700. After the chamber 160 is being refilled with the fluid 170, the light source attachment 600 may get deactivated, and the fluid distributing member 200 may facilitate cleaning of the conveyor belt 700.

In an exemplary embodiment of the present disclosure, the apparatus 1000 may be utilized in conjunction with a conveyor belt having a length of about 69 inches, and a width of about 18 inches. However, the apparatus 1000 may be utilized with a conveyor belt of varying dimensions.

The present disclosure provides an apparatus, such as the apparatus 1000 for cleaning the conveyor belt. The fluid distributing member and the fluid utilized for cleaning the conveyor belt provide a continuous and an easy way of removing the contaminants from the conveyor belt, thereby cleaning the conveyor belt. Accordingly, the apparatus prevents various items placed on the conveyor belt from getting contaminated. Further, the apparatus facilitates cleaning of the conveyor belt after every use and thereby, precludes the use of plastic bags for packaging the various items before placing the items on the conveyor belt. Furthermore, when the level of the fluid contained in the container of the disclosed apparatus falls below the predetermined threshold level of the fluid, the light source attachment may be utilized for cleaning the conveyor belt. Alternatively, the fluid contained in the container and the light source attachment may simultaneously be utilized for cleaning and disinfecting the conveyer belt, thereby enabling a continuous cleaning of the conveyor belt. Moreover, use of the quick drying anti-bacterial fluid leaves the conveyor belt dry after cleaning thereof.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present disclosure.

What is claimed is:

1. An apparatus for cleaning a conveyor belt, the apparatus comprising:
a container having a chamber adapted to store a fluid therein, the chamber terminating in an opening; and
a fluid distributing member extending from the chamber and through the opening, the fluid distributing member being rotatable with respect to the container and capable of receiving the fluid from the chamber and distributing the fluid onto the conveyor belt spaced apart from the container to clean the conveyor belt.

2. The apparatus of claim 1, further comprising a level detector disposed within the container for measuring a level of the fluid in the chamber.

3. The apparatus of claim 2, further comprising at least one indicator operatively coupled to the level detector for providing an indication upon the level of the fluid being less than a predetermined threshold level of the fluid.

4. The apparatus of claim 1, further comprising at least one fastener disposed on an outer surface of the container, the at least one fastener configured to removably attach the container to a support member of the conveyer belt.

5. The apparatus of claim 1, wherein the fluid is a quick drying anti-bacterial fluid.

6. The apparatus of claim 1, wherein the fluid distributing member is a roller.

7. The apparatus of claim 1, further comprising a light source attachment coupled to the container, the light source attachment comprising at least one light source capable of producing ultra violet (UV) light for disinfecting the conveyor belt, thereby cleaning the conveyor belt.

8. The apparatus of claim 7, wherein the at least one light source is adapted to be activated upon the level of the fluid in the chamber being less than a predetermined threshold level of the fluid.

9. The apparatus of claim 7, wherein the light source attachment is made of a water resistant material.
